(19) United States
(12) Patent Application Publication
(10) Pub. No.: US 2008/0308221 A1
(43) Pub. Date: Dec. 18, 2008

(54) Method And System For Removing Tape From Substrates

(76) Inventors: Tan Kian Shing Michael, Singapore (SG); Neo Chee Peng, Singapore (SG); Tan Chee Yong, Singapore (SG)

Correspondence Address: STEPHEN A. GRATTON, 2764 South Braun Way, Lakewood, CO, 80228, US

(21) Appl. No.: 11/779,450

(22) Filed: Jul. 18, 2007

(30) Foreign Application Priority Data
Jun. 15, 2007 (SG) 200704439-9

(51) Int. Cl. B32B 38/10; G05G 15/04

(52) U.S. Cl. 156/247; 156/350

(57) ABSTRACT

A method for removing tape from a substrate includes the step of detecting an actual distance between a peel head and the tape on the substrate, and a location of an edge of the substrate. The method also includes the steps of moving the peel head in a first direction by an amount equal to the distance to press the peel tape onto the tape on the substrate, moving the peel head in a second direction to the edge of the substrate, and then moving the peel head in an opposite second direction to peel the tape from the substrate. The detecting step can be performed using a sensor such as a capacitance probe sensor or an optical sensor. Alternately, rather than detecting the distance, a pressure sensing system can be used to press the peel head against the tape, and to maintain a predetermined pressure range during the peeling process. A system for performing the method includes sensors configured to detect the distance and the edge of the substrate, and a control system configured to control the movement of the peel head responsive to signals from the sensors. A pressure sensing system includes a compression spring and a load cell for sensing pressure, and a stepper motor configured to control movement of the peel head responsive to pressure signals.

### BACKGROUND

A polymer adhesive tape can be used to protect a substrate, such as a semiconductor, glass or ceramic substrate, during various fabrication processes. For example, a semiconductor substrate, such as a semiconductor wafer, can be thinned from the back side to provide thinner and lighter semiconductor components. The thinning process can be performed using a mechanical grinding system, such as a “polish grinder”. During the thinning process, a polymer face tape can be used to protect the integrated circuits and metallization layers contained on the circuit side of the substrate. However, following the thinning process, the tape must be removed from the substrate.

Some systems utilize an integrated taping and de-taping system for attaching and then removing the tape from the substrate. Other systems utilize a stand alone taping and de-taping system. In either case, the de-taping system can include a peel head configured to press a peel tape onto the tape on the substrate, and then to move across the substrate to peel the tape away from the substrate. The peel tape can comprise a high tack or heat or pressure activated tape, that has a higher adhesive force than the tape on the substrate.

One problem with the de-taping system occurs during pressing of the peel head and the peel tape against the tape on the substrate. In conventional de-taping systems, the peel head is configured to move by a fixed amount in the z-direction to place the peel tape in contact with the tape on the substrate, and then to exert a desired amount of pressure for pressing the peel tape against the tape on the substrate. If the movement and pressure of the peel head are insufficient, then the peel tape does not adhere properly to the tape on the substrate. If the movement and pressure of the peel head are too great, then the substrate can be damaged. For example, thinned semiconductor components on a semiconductor wafer can be easily cracked or broken by the pressure applied by a peel head.

Typically, the movement of the peel head is controlled by a pulse motor and an associated micrometer. In a conventional de-taping system, the movement of the peel head is based on a fixed distance between the peel head and the peel table which supports the substrate. However, this fixed distance is affected by numerous factors. One factor that can affect the fixed distance is the flatness and levelness of the peel table. For example, ceramic peel tables have a flatness variation of about 2 μm to 5 μm across a 300 mm diameter substrate. Mechanical levelness of the parts supporting the peel table can also vary by about 2 μm to 5 μm. The peel head can have similar variations in flatness and levelness.

The mechanical backlash of the pulse motor and micrometer which control the peel head can also affect the movement of the peel head. Another factor is the variation in the thickness of the peel tape, which typically ranges between ±5 μm for most peel tapes. Still another factor is the variation in the thickness of the substrate. For example, the thickness of a ground wafer can vary by ±6 μm depending on the type of wafer, and process variations. In systems in which the wafer is also diced using a dicing tape, the thickness of the dicing tape can also add variations in the range of about ±10 μm.

All of these process variables are cumulative and can adversely affect the peeling process. In view of the foregoing, there is a need in the art for a method and a system for removing tape from a substrate in which the movement of the peel head can be controlled independently of process variables.

### BRIEF DESCRIPTION OF THE DRAWINGS

Exemplary embodiments are illustrated in the referenced figures of the drawings. It is intended that the embodiments and the figures disclosed herein are to be considered illustrative rather than limiting.

FIG. 1 is a schematic cross sectional view of a tape removal mechanism configured to remove a tape from a substrate;

FIG. 1A is an enlarged schematic cross sectional view of the tape removal mechanism taken along section line 1A-1A of FIG. 1;

FIG. 1B is a enlarged view of a portion of the tape removal mechanism taken along line 1B of FIG. 1;

FIGS. 2A-2D are schematic cross sectional views illustrating steps in a method for removing tape from a substrate;

FIG. 3 is a schematic cross sectional view of a tape removal system having capacitance probe sensors;

FIG. 4 is a schematic cross sectional view of a tape removal system having an optical sensor;

FIG. 5A is a schematic cross sectional view of a tape removal system having multiple optical sensors including an optical transmitter and an optical receiver;

FIG. 5B is an enlarged schematic diagram taken along line 5B of FIG. 5A illustrating the calculation of distances and angles in the system of FIG. 5A; and

FIG. 6 is a schematic cross sectional view of a tape removal system having pressure sensing components.

### DETAILED DESCRIPTION

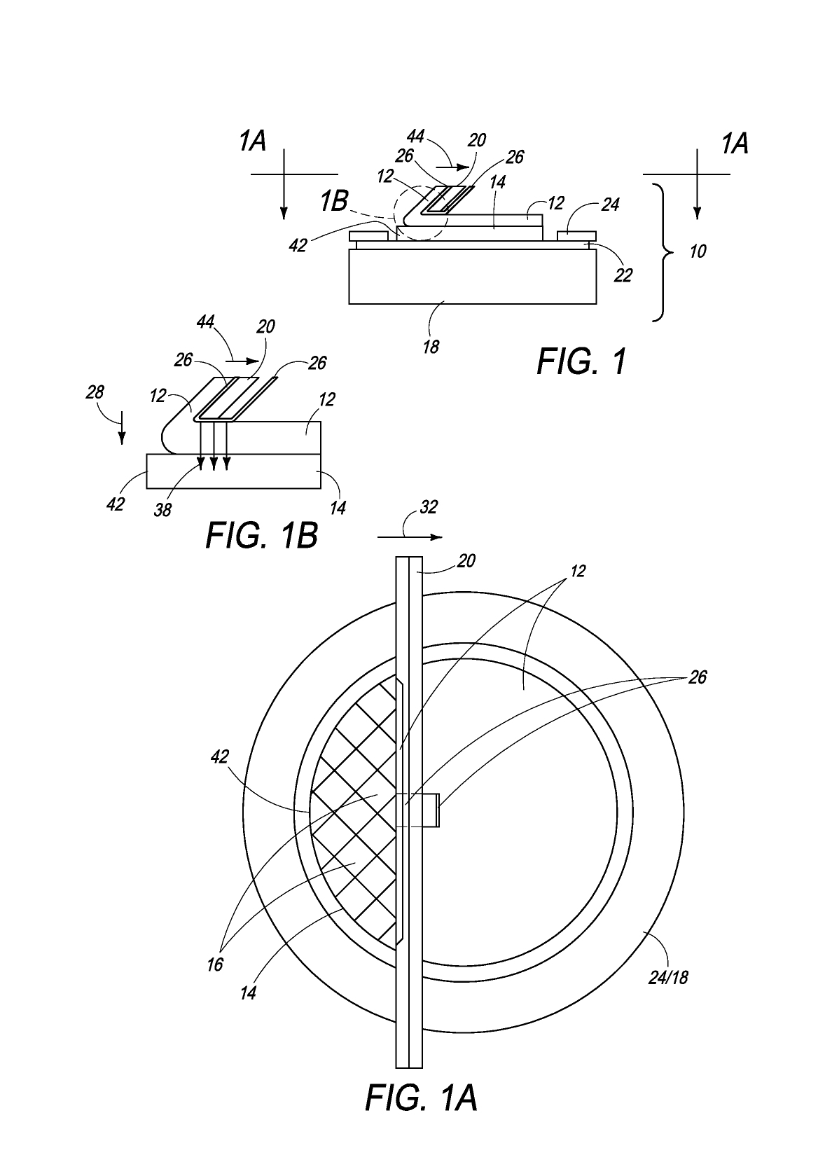

Referring to FIGS. 1, 1A and 1B, a tape removal mechanism 10 (FIG. 1) configured to remove a tape 12 from a substrate 14 is illustrated. The substrate 14 can comprise a semiconductor wafer or portion thereof, a semiconductor die, a ceramic plate, a glass plate or a plastic plate. The tape removal mechanism 10 (FIG. 1) can comprise a component of a de-taping system integrated into another system. For example, with the substrate 14 comprising a semiconductor wafer, the tape removal mechanism 10 (FIG. 1) can comprise a component of a “polish grinder” available from various semiconductor equipment manufacturers for thinning and polishing semiconductor wafers. One such “polish grinder” is available from “ACCRETECH USA” of Austin, Tex. and is designated a “PG300RM Polish Grinder”.

As another alternative, the tape removal mechanism 10 (FIG. 1) can comprise a component of a stand alone tape removal system. Exemplary tape removal systems for semiconductor wafers include: “HR” series de-taper systems manufactured by Nitto Denko Corporation, Osaka, Japan; “ATRM” series de-taper systems manufactured by Takatori Corporation, Kashihara, Japan; and “RAD-3000” series de-taper systems manufactured by Lintec Corporation, Tokyo, Japan.

The substrate 14 (FIG. 1A) can have any conventional size or shape (e.g., circular, polygonal, square, rectangular). For example, the substrate 14 (FIG. 1A) can comprise a whole or partial semiconductor wafer having a selected diameter (e.g., 200 mm, 300 mm, 450 mm). In addition, the substrate 14 can include a plurality of individual components 16 (FIG. 1A), such as semiconductor dice or packages. Also, the components 16 can comprise un-singulated components, or singulated components, depending on whether the substrate 14 has been diced prior to the tape removal process. Also prior to removing the tape 12, the substrate 14 may have been thinned from the back side to a desired thickness.

The tape 12 (FIG. 1) can comprise a conventional polymer tape having an adhesive surface, such as a heat or pressure sensitive adhesive, which adheres to the substrate 14. For example, the tape 12 can comprise a polymer face tape used to protect the circuit side (face) of a semiconductor wafer during a back side thinning process. Polymer face tapes are available from Lintec Corporation, Tokyo, Japan, and from other manufacturers as well.

The tape removal mechanism 10 (FIG. 1) includes a peel table 18, and a peel head 20 configured to manipulate a peel tape 26. The substrate 14 can be mounted to the peel table 18 on a frame 24 having a dicing tape 22. The peel head 20 is movable in a first direction (z-direction) as indicated by z-direction arrow 28 (FIG. 1B), and is configured to press the peel tape 26 against the tape 12 as indicated by force arrows 38 (FIG. 1B). The peel tape 26 has an adhesive strength which is greater than that of the tape 12, such that the peel tape 26 can be pulled with enough force to peel the tape 12 from the substrate 14. The peel head 20 is also movable in a second direction (x-direction) across the substrate 14 as indicated by x-direction arrow 44 for peeling the tape 12 from the substrate 14. A peel tape roller (not shown) supplies fresh peel tape 26 to the peel head 20, and a waste tape roller (not shown) receives the used tape 12 and attached peel tape 26 for disposal.

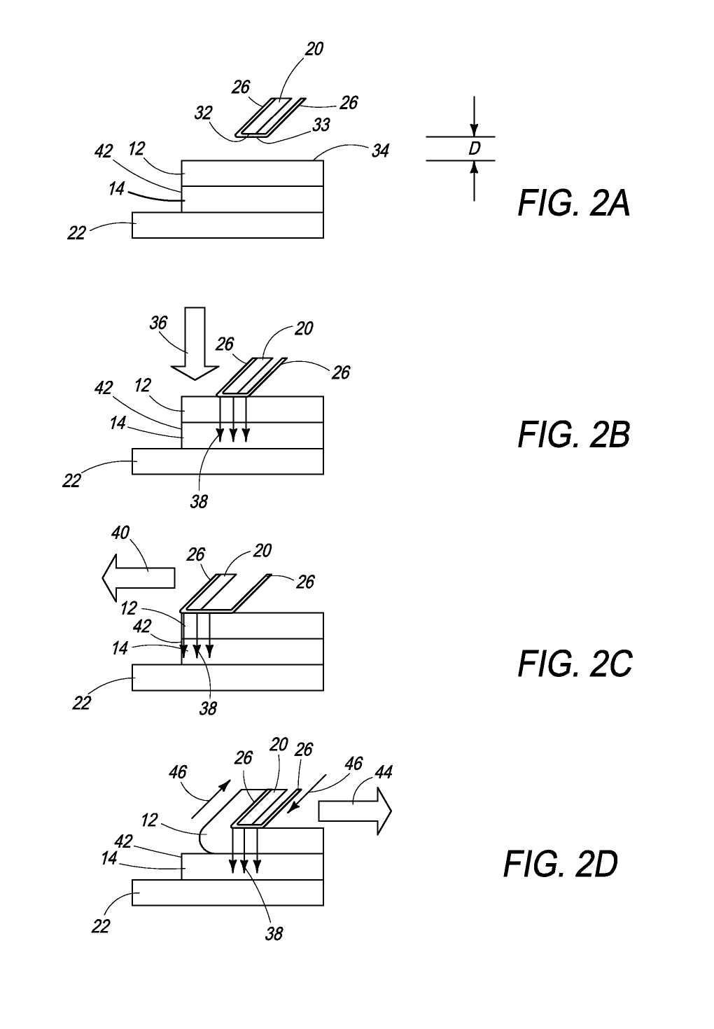

Referring to FIGS. 2A-2D, steps in the method for removing the tape 12 from the substrate 14 are illustrated. As shown in FIG. 2A, the method includes the step of providing the peel head 20 and the peel tape 26 on the peel head 20. The peel head and the peel tape 26 are initially spaced from the surface 34 of the tape 12. The method also includes the step of detecting the actual distance D between the surface 32 of the peel head 20, and the surface 34 of the tape 12 on the substrate 14. As will be further explained, the distance D can be detected using suitable sensors, such as capacitance probe sensors or optical probe sensors. In any case, the distance D is the actual distance between the surface 32 of the peel head 20 and the tape 12, rather than a fixed distance between the peel head 20 and the peel table 18 (FIG. 1), as in prior art methods and systems for removing tape from a substrate. With the actual distance D detected, variations in the thicknesses and planarity of the tape 12, the substrate 14, the dicing tape 22 and the peel table 18 will not affect the tape removal process. As a variation for performing the detecting step, the distance D (FIG. 2A) can comprise the distance between the surface 33 (FIG. 2A) of the peel tape 26 on the peel head 20, and the surface 34 of the tape 12.

Next, as shown in FIG. 2B, the method includes the step of moving the peel head 20 in the first direction (z-direction) towards the tape 12 by the distance D, as indicated by z-direction arrow 36. As also shown in FIG. 2B, the peel head 20 is operated to press the peel tape 26 against the tape 12 with a selected force F, as indicated by force arrows 38. As both the movement of the peel head 20, and the selected force F, are a function of the previously detected distance D, process control is improved over prior art methods in which a fixed distance between the peel head 20 and the peel table 18 (FIG. 1) is utilized.

Next, as shown in FIG. 2C, the method includes the step of detecting a location of an edge 42 of the substrate 14, and then moving the peel head 20 in the second direction (x-direction) as indicated by x-direction arrow 40 to the edge 42 of the substrate 14. At the same time, the peel head 20 continues to press the peel tape 26 against the tape 12 with the selected force F, as indicated by force arrows 38. This movement increases the contact area between the peel tape 26 and the tape 12, as more peel tape 26 is pressed against the tape 12. In addition, by detecting the edge 42 of the substrate 14, the peel head 20 can be accurately positioned without over-traveling and contacting the dicing tape 22 rather than the tape 12.

Next, as shown in FIG. 2D, the method includes the step of moving the peel head 20 in the second direction (x-direction but opposite to x-direction arrow 40) across the substrate 14 to peel the tape 12 from the substrate 14, as indicated by the x-direction arrow 44. At the same time, the waste tape roller (not shown) rolls up the peel tape 26 and the used tape 12, as indicated by waste tape roll up arrows 46. During the peeling and waste tape rolling process, the peel head 20 continues to press the peel tape 26 against the tape 12, as indicated by force arrows 38.

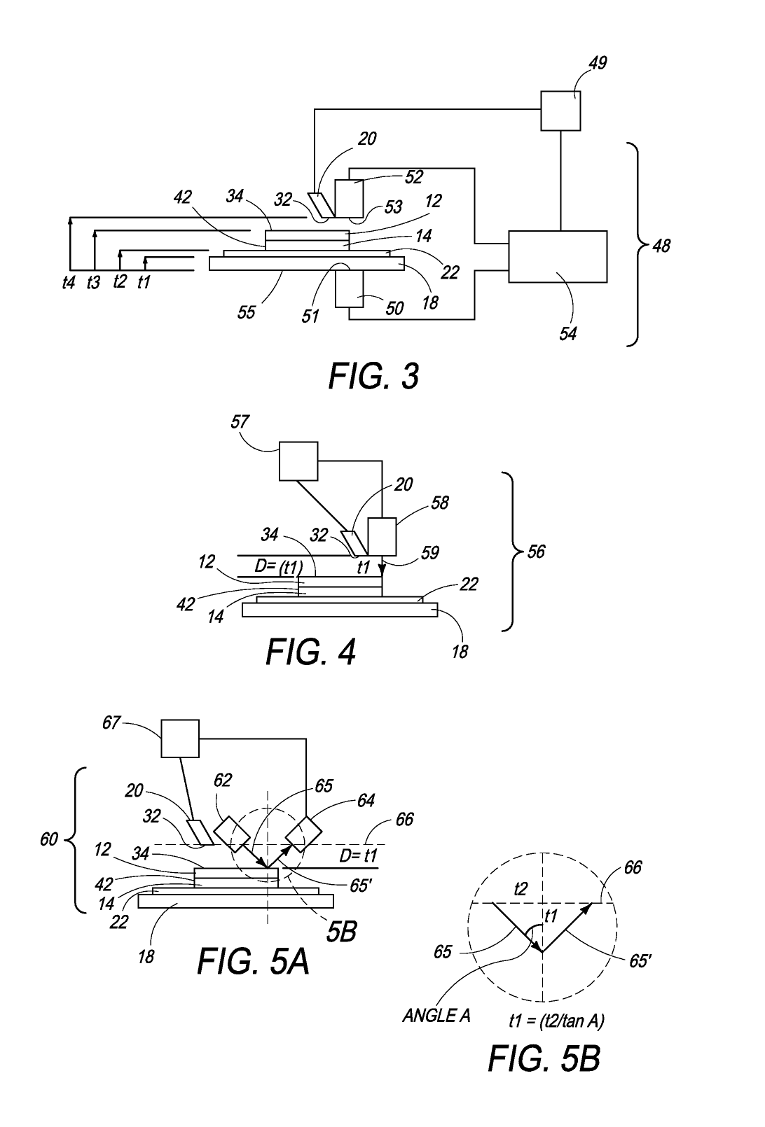

Referring to FIG. 3, a capacitance sensor system 48 configured to perform the method of FIGS. 2A-2D is illustrated. The capacitance sensor system 48 comprises at least one pair of capacitance sensors including: a first capacitance sensor 50 having a sensing surface 51 located proximate to the peel table 18, and a second capacitance sensor 52 having a sensing surface 53 located proximate to the peel head 20. Although the capacitance sensor system 48 is illustrated with only one pair of capacitance sensors 50, 52, it is to be understood that the capacitance sensor system 48 can include multiple pairs of capacitance sensors 50, 52. The capacitance sensor system 48 also includes an analyzer 54 in signal communication with the capacitance sensors 50, 52.

The capacitance sensors 50, 52 (FIG. 3) are configured to sense changes in capacitances between their sensing surfaces 51, 53 and various target surfaces. For example, the target surfaces can be surfaces on the peel table 18, the dicing tape 22, the substrate 14, the edge 34 of the substrate 14, the tape 12, and the peel head 20. The changes in capacitance measured by the capacitance sensors 50, 52 can then be used to detect the distances t1, t2, t3, and t4 (FIG. 3). The distance D (FIG. 2A) in the method of FIGS. 2A-2D is equal to the distance t4 (FIG. 3) minus the distance t3 (FIG. 3). The detection of the distance D can be used to move the peel head 20 in the first direction 36 (z-direction) into contact with the tape 12, substantially as shown in FIG. 2B. The changes in capacitance can also be used to detect the location of the edge 42 of the substrate 14. The detection of the location of the edge 42 of the substrate 14 can be used to move the peel head 20 in the second direction 40 (x-direction) to the edge 42 of the substrate 14, substantially as shown in FIG. 2C.

In the capacitance sensor system 48 (FIG. 3), the sensing surface 51 of the first capacitance sensor 50 can be coincident to a lower surface 55 of the peel table 18. The sensing surface 53 of the second capacitance sensor 52 can be coincident to the surface 32 of the peel head 52. The distance t1 (FIG. 3) can be equal to the thickness of the peel table 18. The distance t2 (FIG. 3) can be equal to the combined thicknesses of the peel table 18 and the dicing tape 22. The distance t3 (FIG. 3) can be equal to the combined thicknesses of the peel table 18, the dicing tape 22, the substrate 14 and the tape 12. The distance t4 (FIG. 3) can be equal to the combined thicknesses of the peel table 18, the dicing tape 22, the substrate 14 and the tape 34 plus the distance D between the surface 34 of the tape 12 and the surface 32 of the peel head 20.

The analyzer 54 (FIG. 3) can include driver electronics that convert the changes in capacitances into voltage changes, and a data acquisition system that uses the voltage changes to determine distances. The analyzer 54 can also be in signal communication with a control system 49 configured to control the movement of the peel head 20 responsive determination of the distance D. Suitable capacitance sensors and analyzers are available from a variety of manufacturers including Lion Precision of St. Paul, Minn.

Referring to FIG. 4, an optical sensor system 56 configured to perform the method of FIGS. 2A-2D is illustrated. The optical sensor system 56 includes at least one optical sensor 58 configured to direct a light beam 59 onto the surface 34 of the tape 12, and to use a reflected beam (not shown) to detect the actual distance t1 between the surface 32 of the peel head 20 and the surface 34 of the tape 12. The optical sensor 58 can comprise any suitable optical distance measuring device, such as an optical micrometer, or a laser micrometer. Although only one optical sensor 58 is illustrated in the optical sensor system 56 of FIG. 4, it is to be understood that the optical sensor system 56 can include multiple optical sensors 58.

The distance t1 (FIG. 4) is equal to the distance D in the method of FIGS. 2A-2D. This information can be used to control the movement of the peel head 20 substantially as previously described. For example, the optical sensor 58 can be in signal communication with a control system 57 configured to control the movement of the peel head 20 in the first direction 36 (z-direction) responsive to determination of the distance D, substantially as shown in FIG. 2B. The optical sensor 58 can also be used to detect the location of the edge 42 of the substrate 12. This information can be used to control movement of the peel head 20 in the second direction 40 (x-direction) to the edge 42 of the substrate 12, substantially as shown in FIG. 2C.

As another alternative, the optical sensor 58 (FIG. 4) can be configured to detect other distances, such as the distance between the surface 33 (FIG. 2A) of the peel tape 26 and the surface 34 of the tape 12 on the substrate 14, the distance between the peel head 20 and the surface of the dicing tape 22, or the distance between the peel head 20 and the peel table 18. These distances can then be used to calculate the distance D (FIG. 2A) and the location of the edge 42 of the substrate 12, and to control the movement of the peel head 20.

Referring to FIG. 5A, a second optical sensor system 60 configured to perform the method of FIGS. 2A-2D is illustrated. The optical sensor system 60 includes a first optical sensor 62 (optical transmitter) and a second optical sensor 64 (optical receiver). The first optical sensor 62 is configured to direct a light beam 65 from a reference plane 66 coincident to the surface 32 of the peel head 20. In addition, a reflected light beam 65′ is reflected off the surface 34 of the tape 12 and onto the second optical sensor 64.

As shown in FIG. 5B, the distance t1 can be calculated using simple geometrical relationships, such as t1=t2/tan angle A, where t1 is orthogonal to the reference plane 66. In addition the distance t1 is equal to the distance D (FIG. 2A). The second optical sensor 64 (FIG. 5A) can be in signal communication with a control system 67 (FIG. 5A) configured to control the movement of the peel head 20 responsive to detection of the distance D. As with the optical sensor system 56 (FIG. 4), the optical sensor system 60 (FIG. 5A) can include multiple first optical sensors 62 (FIG. 5A) and multiple second optical sensors 64 (FIG. 5A). In addition, the optical sensors 62, 64 can be used to detect the edge 42 of the substrate 14, and to control the movement of the peel head 20 to the edge 42 of the substrate 14, substantially as previously described in FIG. 2C.

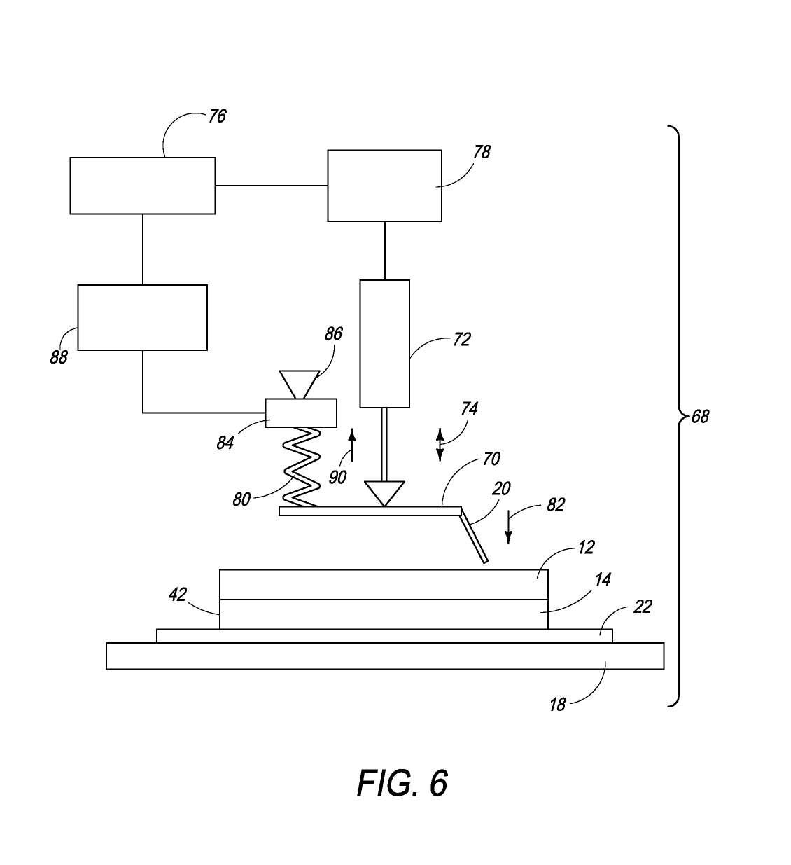

Referring to FIG. 6, a pressure sensing system 68 configured to substantially perform the method of FIGS. 2A-2D is illustrated. However there is a difference in that the pressure sensing system 68, rather than detecting the distance D (FIG. 2A) and moving the peel head by the distance D, senses the pressure of the peel head 20 on the tape 12, and maintains a predetermined pressure. The pressure sensing system 68 includes a peel body mechanism 70 and a stepper motor 72 configured to move the peel head 20 in opposing z-directions into and out of contact with the tape 12, as indicated by double headed z-direction arrow 74. A controller 76 and a motor driver 78 control the operation of the stepper motor 72, and thus the movement of the peel body mechanism 70 and the peel head 20.

The pressure sensing system 68 (FIG. 6) also includes a compression spring 80 associated with the peel body mechanism 70, which senses the pressure of the peel head 20 on the tape 12, as indicated by pressure arrow 82. The compression spring 80 is connected to a load cell 84 having a preload mechanism 86 for setting a desired amount of pressure for the peel head 20 on the tape 12. The compression spring 80 is also in signal communication with a pressure amplifier 88, which is in signal communication with the controller 76.

During operation of the pressure sensing system 68 (FIG. 6), the peel body mechanism 70 is initially moved in a first direction 82 (z-direction) such that the peel head 20 contacts the tape 12. As the peel head 20 contacts the tape 12, the peel body mechanism 70 moves upward as indicated by arrow 90, compressing the spring 80 and the load cell 84. The load cell 84 produces a change in output voltage which is proportional to the pressure applied by the peel head 20 on the tape 12. This voltage is transmitted through the pressure amplifier 88 and the controller 76 to the motor driver 78 to control the stepper motor 72 and the movement of the peel head 20 in the first direction 82 (z-direction), as a function of the pressure set by the preload mechanism 86. The stepper motor 72 can also be operated to reverse the direction of movement of the peel head 20 (opposite z-direction) to reduce the pressure of the peel head 20 on the tape 12. The pressure sensing system 68 thus functions to maintain the pressure of the peel head 20 on the tape 12 in a predetermined range, as the peel head 20 peels face tape 12 from the substrate 14 (see FIG. 2D).

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

1. A method for removing a tape from a substrate comprising:
providing a peel tape on a peel head spaced from the tape and configured to peel the tape from the substrate;
detecting an actual distance between the peel head or the peel tape and the tape on the substrate;
moving the peel head and the peel tape in a first direction towards the tape by an amount equal to the distance;
pressing the peel tape into contact with the tape; and
moving the peel head in a second direction across the substrate to peel the tape from the substrate.

2. The method of claim 1 further comprising detecting a location of an edge of the substrate, and following the pressing step moving the peel head in an opposing second direction to the edge.

3. The method of claim 1 wherein the detecting step is performed using at least one pair of capacitance sensors configured to measure a change in capacitance between sensing surfaces and selected target surfaces.

4. The method of claim 1 wherein the detecting step is performed using at least one optical sensor configured to direct a light beam onto the tape.

5. The method of claim 1 wherein the detecting step is performed using a first optical sensor configured to direct a light beam onto the tape and a second optical sensor configured to receive a reflected light beam from the tape.

6. The method of claim 1 wherein the substrate comprises a semiconductor wafer, and the detecting step is performed with the wafer mounted on a dicing tape to a peel table.

7. (canceled)

8. A method for removing a tape from a substrate comprising:
providing a peel table configured to support the substrate, and a peel tape on a peel head configured to peel the tape from the substrate on the peel table; providing a first capacitance sensor having a first sensing surface located proximate to the peel table, and a second capacitance sensor having a second sensing surface located proximate to the peel head;
sensing changes in capacitances between the first sensing surface and the second sensing surface, and target surfaces on the peel table, the substrate, the tape, and the peel head;
using the changes in capacitance to detect an actual distance between the peel head and the tape or between the peel tape on the peel head and the tape;
moving the peel head and the peel tape in a first direction by an amount equal to the distance;
pressing the peel tape into contact with the tape; and
moving the peel head in a second direction to peel the tape from the substrate.

9. The method of claim 8 further comprising using changes in capacitance to detect a location of an edge of the substrate and moving the peel head in an opposing second direction to the edge prior to the moving the peel head in the second direction step.

10. The method of claim 8 further comprising performing the using the changes step using an analyzer in signal communication with the first capacitance sensor and the second capacitance sensor.

11. The method of claim 10 further comprising providing a control system in signal communication with the analyzer and controlling movement of the peel head using the control system.

12. (canceled)

13. The method of claim 8 wherein the substrate comprises a semiconductor wafer mounted to a dicing tape on the peel table, and further comprising sensing a change in capacitance between a surface of the dicing tape and the first sensing surface or the second sensing surface, and using the change in capacitance to sense the distance.

14. A method for removing a tape from a substrate comprising:
providing a peel table configured to support the substrate, and a peel tape on a peel head configured to peel the tape from the substrate on the peel table;
providing at least one optical sensor configured to detect an actual distance between a surface of the peel head or the peel tape and a surface of the tape, and to detect a location of an edge of the substrate;
detecting the distance and the location of the edge of the substrate using the optical sensor;
moving the peel head and the peel tape in a first direction by an amount equal to the distance;
pressing the peel tape into contact with the surface of the tape with a selected pressure;
moving the peel head in a second direction to the edge of the substrate; and
moving the peel head in an opposing second direction to peel the tape from the substrate.

15. The method of claim 14 wherein the substrate comprises a semiconductor wafer is mounted to a dicing tape on the peel table during the moving the peel head and the peel tape step, the pressing the peel tape step and the moving peel head step.

16. (canceled)

17. The method of claim 14 wherein the optical sensor includes a first sensor configured to direct a light beam onto the tape and a second sensor configured to receive a reflected light beam from the tape.

18. A method for removing a tape from a substrate comprising:
providing a peel tape on a peel head configured to peel the tape from the substrate;
moving the peel head and the peel tape in a first direction by a distance sufficient to press the peel tape into contact with the tape with a pressure;
moving the peel head in a second direction to peel the tape from the substrate;
sensing the pressure; and
maintaining the pressure in a predetermined range by moving the peel head in the first direction or in an opposing direction responsive to the sensing step.

19. The method of claim 18 wherein the sensing step is performed using a compression spring, a load cell, and a stepper motor in signal communication with the load cell.

20. The method of claim 18 wherein the substrate comprises a semiconductor wafer, and the moving the peel head and the peel tape step is performed with the wafer mounted on a dicing tape to a peel table.

21. A system for removing a tape from a substrate comprising:
a peel table configured to support the substrate;
a peel tape on a peel head configured to peel the tape from the substrate on the peel table;
at least one sensor configured to detect an actual distance between a surface of the peel head or the peel tape and a surface of the tape; and
a control system in signal communication with the sensor configured to move the peel head by the distance such that the peel tape contacts the tape.

22. The system of claim 21 wherein the sensor comprises a first capacitance sensor located proximate to the peel table and a second capacitance sensor located proximate to the peel head.

23. The system of claim 21 wherein the sensor comprises an optical sensor configured to direct a light beam from a plane coincident to a surface of the peel head onto the tape.

24. The system of claim 21 wherein the sensor comprises a first optical sensor configured to direct a light beam onto the tape and a second optical sensor configured to receive a reflected light beam from the tape.

25. The system of claim 21 wherein the sensor comprises an optical micrometer or a laser micrometer.

26. The system of claim 21 wherein the substrate comprises a semiconductor wafer and the peel head is a component of a polish grinder configured to thin the wafer, or a stand alone de-taper configured to remove a face tape from the wafer.

27-35. (canceled)

36. The system of claim 21 wherein the sensor comprises a first capacitance sensor having a first sensing surface and a second capacitance sensor having a second sensing surface, the first capacitance sensor and the second capacitance sensor configured to sense changes in capacitances between the first sensing surface and the second sensing surface and target surfaces on the peel table, the substrate, the tape, and the peel head.

37. The system of claim 36 wherein the control system comprises an analyzer in signal communication with the first capacitance sensor and the second capacitance sensor configured to use the changes in capacitance to detect an actual distance between the peel head or the peel tape and the tape.
